(19) United States
(12) Patent Application Publication
(10) Pub. No.: US 2018/0165624 A1
(43) Pub. Date: Jun. 14, 2018

(54) SYSTEMS, DEVICES, AND METHODS FOR PROVIDING INTERACTIVE PHARMACY SERVICES

(71) Applicant: Wal-Mart Stores, Inc., Bentonville, AR (US)

(72) Inventors: Sunil K. Pati, Bentonville, AR (US); Bradley Joseph Kieffer, Rogers, AR (US); Eytan Daniyalzade, San Francisco, CA (US); Prasanna Rajendran, Bentonville, AR (US); Berk Atikoglu, San Francisco, CA (US); Nidhi Sadanand, Bangalore (IN); Nitin Kaulavkar, Bangalore (IN); Hudson Levy, San Francisco, CA (US); Sajida Kaliyadan, San Francisco, CA (US); David Martin Nelms, Rogers, AR (US)

(21) Appl. No.: 15/423,533

(22) Filed: Feb. 2, 2017

(30) Foreign Application Priority Data
Dec. 12, 2016 (IN) 201611042319

(51) Int. Cl. G06Q 10/08; G06Q 20/40; G06Q 50/22

(52) U.S. Cl. CPC G06Q 10/087; G06Q 50/22; G06Q 20/4014

(57) ABSTRACT

Methodologies, systems, and computer-readable media are provided for processing pharmacy orders. A pharmacy services management module can receive a pharmacy order and transmit a first notification to a mobile electronic device once the pharmacy order is filled. The first notification can indicate that the pharmacy order is ready for pickup as well as a price associated with the pharmacy order. A broker computing system executes a user identification module and receives a location identifier and user identification data from an application executing on the mobile electronic device. A user check-in module receives the user identification data from the user identification module and retrieves the user's pharmacy order from the pharmacy services management module. The user check-in module can process payment for the pharmacy order and transmit a second notification to the application once the payment is processed.

### RELATED APPLICATIONS

This application claims priority to Indian Patent Application No. 201611042319 entitled “SYSTEMS, DEVICES, AND METHODS FOR PROVIDING INTERACTIVE PHARMACY SERVICES,” filed on Dec. 12, 2016, the content of which is hereby incorporated by reference in its entirety.

### BACKGROUND

Various types of pharmacy products can be ordered by pharmacy customers. Processing these pharmacy orders requires user authentication before the order can be dispensed.

### SUMMARY

Embodiments of the present invention utilize a mobile application in concert with a broker system to verify a user's identity and process pharmacy orders. For example, using a mobile application, a pharmacy order can be initiated and filled prior to the user entering the store and the user can be automatically identified through the mobile application, thus reducing the time it takes to verify pharmacy orders and process pharmacy order payments.

In one embodiment, a system for generating pharmacy orders is disclosed. The system includes a server configured to execute a pharmacy services management module. The pharmacy services management module, when executed, receives a pharmacy order over a network from an application executing on a mobile electronic device associated with a user, and transmits a first notification to the application executing on the mobile electronic device in response to a pharmacy order being processed. The first notification indicates that the pharmacy order is ready for pickup and indicates a price associated with the pharmacy order. The system also includes a broker computing system configured to execute a user identification module. The user identification module, when executed, receives from the application executing on the mobile electronic device a location identifier and user identification data, and transmits a second notification to the application executing on the mobile electronic device in response to a payment for the pharmacy order being processed. The location identifier is determined in response to the mobile electronic device scanning a machine readable code located at a pharmacy location that indicates the location identifier. The system also includes a computing device located in proximity to the pharmacy location and configured to execute a user check-in module. The user check-in module, when executed, receives the user identification data from the user identification module, retrieves the pharmacy order associated with the user from the pharmacy services management module following receipt of the user identification data, transmits a technician notification to a pharmacy technician that the user is available to receive the pharmacy order, and processes the payment for the pharmacy order.

In another embodiment, a system for generating pharmacy orders is disclosed that includes a server configured to execute a pharmacy services management module. When executed, the pharmacy services management module receives a pharmacy order associated with a user and transmits a first notification to an application executing on a mobile electronic device associated with the user in response to a pharmacy order being processed. The first notification indicates that the pharmacy order is ready for pickup and indicates a price associated with the pharmacy order. The system also includes a broker computing system configured to execute a user identification module that, when executed, receives from the application executing on the mobile electronic device a location identifier that identifies a pharmacy location and user identification data. The user identification module also transmits a second notification to the application executing on the mobile electronic device in response to a payment for the pharmacy order being processed. The system also includes a computing device located in proximity to the pharmacy location and configured to execute a user check-in module. When executed, the user check-in module receives the user identification data from the user identification module, retrieves the pharmacy order associated with the user from the pharmacy services management module following receipt of the user identification data, transmits a technician notification to a pharmacy technician that the user is available to receive the pharmacy order, and initiates processing of the payment for the pharmacy order associated with the user.

In another embodiment, a method for generating pharmacy orders is disclosed. The method includes receiving, at a server configured to execute a pharmacy services management module, a pharmacy order over a network from an application executing on a mobile electronic device associated with a user. The method also includes transmitting a first notification from the pharmacy services management module to the application executing on the mobile electronic device in response to the pharmacy order being processed, wherein the first notification indicates that the pharmacy order is ready for pickup and indicates a price associated with the pharmacy order. The method also includes providing a machine readable code at a pharmacy location that provides a location identifier to the application executing on the mobile electronic device in response to being scanned by the mobile electronic device. The method also includes receiving from the application executing on the mobile electronic device, at a user identification module executed by a broker computing system, the location identifier and user identification data. The method also includes receiving the user identification data, from the user identification module, at a user check-in module executed by a computing device located in proximity to the pharmacy location. The method further includes retrieving the pharmacy order associated with the user from the pharmacy services management module using the user check-in module following receipt of the user identification data. The method additionally includes transmitting a technician notification to a pharmacy technician that the user is available to receive the pharmacy order. The method also includes processing a payment for the pharmacy order associated with the user and transmitting a second notification from the user identification module to the application executing on the mobile electronic device in response to the payment for the pharmacy order being processed.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for generating pharmacy orders, according to an exemplary embodiment.

FIG. 2 is a flowchart illustrating another exemplary method for generating pharmacy orders, according to another exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for generating pharmacy orders. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present invention, methodologies, systems, apparatus, and non-transitory computer-readable media are described herein to facilitate generating pharmacy orders. In exemplary embodiments, a pharmacy services management module receives pharmacy orders and transmits notifications to an application executing on a mobile electronic device associated with a user. The pharmacy orders can be received, in some embodiments, from the application executing on the user's mobile electronic device. Once the pharmacy order is processed and ready for pickup, the pharmacy services management module can generate and transmit a first notification indicating that the pharmacy order is ready for pickup and indicating the price associated with the order. In some embodiments, additional pharmacy order details can be displayed via the mobile application, such as an explanation of insurance benefits, what discounts apply, and what amount the user is responsible for. In some embodiments, the user can provide an electronic signature or may be able to resolve any issues with insurance before arriving at the pharmacy by using the mobile application. In exemplary embodiments, the user can create an online account that includes the user's personal information, billing information, or any other personalized information that may be used in generating and processing a pharmacy order. Using the mobile application, the user can access this online account and select a payment option before arriving at the pharmacy location. In some embodiments, a secondary form of authentication, such as a PIN, touch ID, or electronic signature may be required in order to process the pharmacy order or the pharmacy order payment and may be entered via the mobile application.

In some embodiments, once the user arrives at the pharmacy location to pick up the pharmacy order, the user's mobile electronic device can communicate with a broker computing system to verify the user's identity. In some embodiments, the mobile electronic device can scan a computer readable code at the pharmacy location in order to retrieve a location identifier indicating where the user wishes to complete the pharmacy order. The broker computing system can parse the location data received from the mobile electronic device to determine the user's location and can execute a user identification module in order to verify the user's identity.

Once the user's identity has been verified, the user identification module can transmit the user's identification data to a user check-in module that is executed by a computing device located at the pharmacy location. This user check-in module retrieves the appropriate pharmacy order from the pharmacy services management module, based on the user identification data. The user check-in module also transmits a notification to a pharmacy technician, in some embodiments, letting the technician know that the user is available to receive the pharmacy order, as well as the location of the user. Once the pharmacy order is ready, the user can complete the transaction by interacting with the user check-in module. In some embodiments, the check-in module can interact with the mobile application to automatically process the pharmacy order payment without the user needing to communicate personal information to a pharmacy technician. Once the pharmacy order has been completed and payment has been processed, a receipt notification can be sent to the user via the mobile application. This receipt notification can include payment details, medical information related to the pharmacy order, an explanation of insurance benefits, etc.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

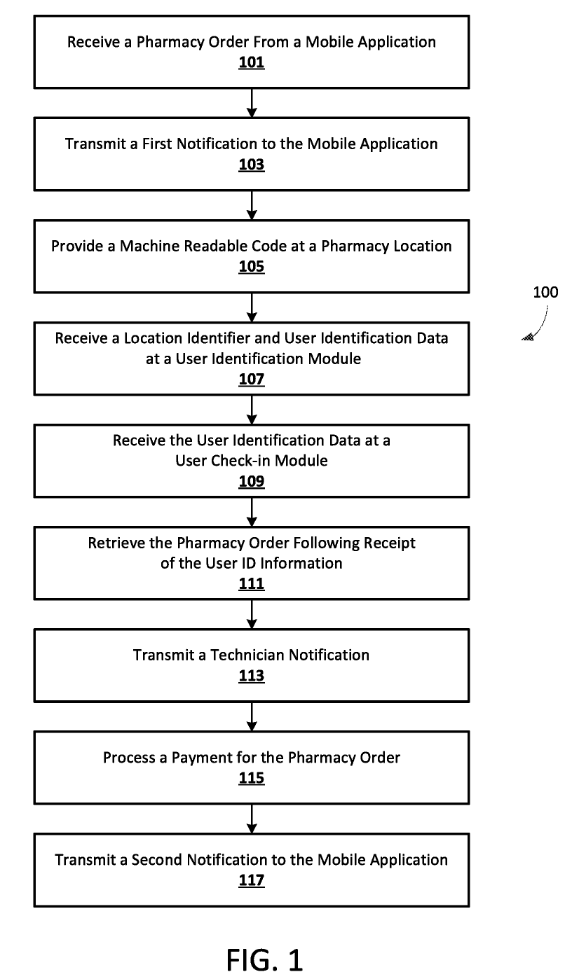

FIG. 1 is a flowchart illustrating an exemplary method 100 for generating pharmacy orders in an exemplary embodiment. It will be appreciated that the method is programmatically performed by one or more computer-executable processes executing on, or in communication with one or more servers described further below. In step 101, a server executes a pharmacy services management module in order to receive a pharmacy order over a network from an application executing on a user's mobile electronic device. In some embodiments, the user can transmit the pharmacy order to the pharmacy services management module using the mobile application in order to initiate processing of the pharmacy order. In some embodiments, the user has created an online account that includes billing information, insurance information, and the address of the pharmacy where the user will pick up orders and prescriptions. Once the pharmacy order has been received at the pharmacy services management module, a pharmacy technician at a designated location can begin processing the order and preparing it for pick up.

In step 103, a first notification is transmitted from the pharmacy services management module to the application executing on the mobile electronic device in response to the pharmacy order being processed. In some embodiments, the first notification indicates that the pharmacy order is ready for pickup and indicates a price associated with the pharmacy order. The first notification can also include medical information relating to the pharmacy order. In some embodiments, the user can interact with the mobile application to resolve insurance errors or electronically sign forms before picking up the pharmacy order.

In step 105, a machine readable code, such as a QR code, a one-dimensional barcode, a two-dimensional barcode, a matrix barcode, etc., is provided at the pharmacy location. The machine readable code provides a location identifier to the user's mobile electronic device when scanned by the mobile electronic device. In some embodiments, the user can scan the machine readable code using a camera of the mobile electronic device. In some embodiments, Bluetooth or other wireless technologies can be used in order to provide a location identifier to the user's mobile electronic device. In other embodiments, the machine readable code can be generated on the user's mobile electronic device and scanned by an electronic device located at the pharmacy location.

In step 107, a user identification module receives the location identifier and user identification data from the application executing on the mobile electronic device. In some embodiments, the user identification module is executed by a broker computing system in order to verify the identity of the user. The user identification data and the user's pharmacy data can be stored, in some embodiments, using a user account module.

In step 109, a user check-in module receives the user identification data from the user identification module. The user check-in module can be executed by a computing device located in, or in proximity to, the pharmacy location. In some embodiments, the machine readable code is located on or next to the computing device that executes the user check-in module. In some embodiments, the user check-in module is located at an express lane at the pharmacy location and the user can request processing of the pharmacy order at the express lane via the mobile application discussed above.

In step 111, the user check-in module retrieves the user's pharmacy order from the pharmacy services management module after receipt of the user identification data in step 109. In some embodiments, the pharmacy services management module can receive a number of pharmacy orders from different users, and once the user check-in module knows the identity of the user, it can retrieve the appropriate pharmacy order from the pharmacy services management module.

In step 113, a technician notification is transmitted to a pharmacy technician in order to notify the technician that the user is available to receive the pharmacy order. In some embodiments, the technician notification can be an audio notification, a notification sent to a mobile electronic device, or a notification sent to a workstation associated with the pharmacy technician.

In step 115, the payment for the user's pharmacy order is processed. In some embodiments, the user has already provided payment information using the user's online account that can be accessed using the application executing on the mobile electronic device. The payment can be processed, for example, using the user check-in module or some other point of sale terminal at the pharmacy location.

In step 117, once the payment of the pharmacy order has been processed a second notification is transmitted from the user identification module to the application executing on the mobile electronic device. In some embodiments, the second notification includes a receipt of the pharmacy order and may include medical details relating to the pharmacy order that has just been processed.

In some embodiments, additional authentication measures, such as a digital signature, are needed in order to process the pharmacy order. In such embodiments, one or more digital signatures associated with the user can be stored at a database or storage location. The digital signature can be retrieved to process the user's pharmacy order, and the digital signature can be received via the application executing on the mobile electronic device.

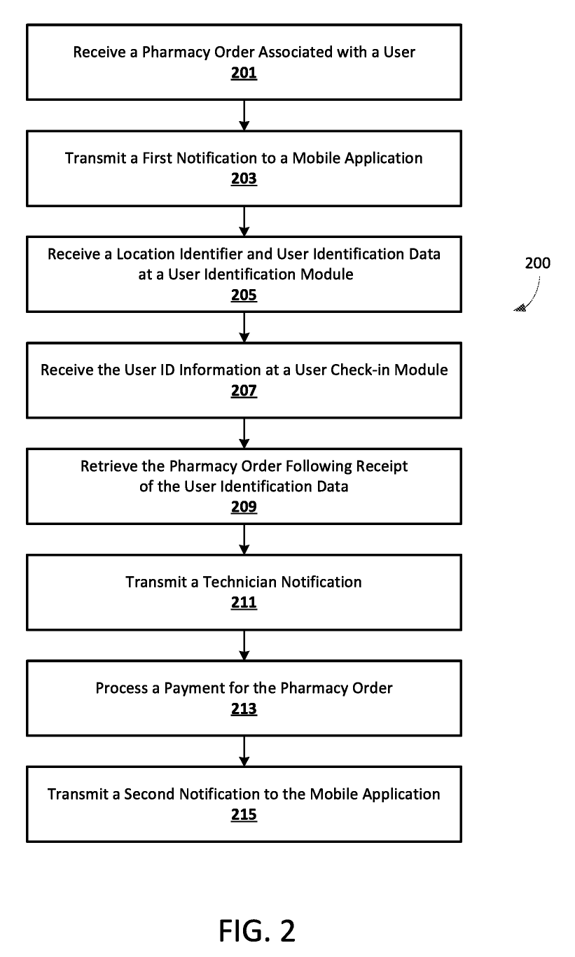

FIG. 2 is a flowchart illustrating another exemplary method 200 for generating pharmacy orders, according to another exemplary embodiment. It will be appreciated that the method is programmatically performed by one or more computer-executable processes executing on, or in communication with one or more servers described further below. In step 201, a server executes a pharmacy services management module in order to receive a pharmacy order. In some embodiments, the pharmacy order can be received from a doctor's office, or through an online account associated with a user. In some embodiments, the user's online account includes billing information, insurance information, and the address of the pharmacy where the user will pick up orders. Once the pharmacy order has been received at the pharmacy services management module, a pharmacy technician can begin processing the order and preparing it for pick up.

In step 203, once the pharmacy order has been processed, the pharmacy services management module generates a first notification and transmits the first notification to an application executing on a mobile electronic device associated with the user. The first notification can indicate that the pharmacy order is ready for pickup and can include, for example, the price of the pharmacy order or medical information relating to the pharmacy order.

In step 205, a user identification module executing on a broker computing system receives a location identifier from the application executing on the mobile electronic device. This location identifier identifies a pharmacy location where the user wishes to pick up the pharmacy order, as well as user identification data. In some embodiments, the user has created an online account that includes user identification data, and the user identification data can be transmitted to the user identification module from the online account or from the mobile electronic device. In some embodiments, the user's mobile electronic device can determine the location identifier by scanning a machine readable code at the pharmacy location, as discussed above, or using Bluetooth or other wireless technologies.

In step 207, a computing device located in proximity to the pharmacy location executes a user check-in module to receive the user identification data from the user identification module. Once the user check-in module receives the user identification data, it can retrieve the appropriate pharmacy order from the pharmacy services management module in step 209. In some embodiments, the pharmacy services management module can receive a number of different orders from various users, and the user check-in module can select the appropriate pharmacy order based on the user identification data received in step 207.

In step 211, a technician notification is transmitted to a pharmacy technician in order to notify the technician that the user is available to receive the pharmacy order. In some embodiments, the technician notification can be an audio notification, a notification sent to a mobile electronic device, or a notification sent to a workstation associated with the pharmacy technician.

In step 213, the payment for the user's pharmacy order is processed. In some embodiments, the payment information can be provided by the user via the user's online account or the application executing on the mobile electronic device. The payment can be processed, for example, using the user check-in module or some other point of sale terminal at the pharmacy location.

In step 215, once the payment for the pharmacy order has been processed, the user identification module generates a second notification and transmits the second notification to the application executing on the mobile electronic device. The second notification can include, for example, a receipt for the pharmacy order, medical details relating to the pharmacy order, an explanation of insurance benefits relating to the pharmacy order, etc.

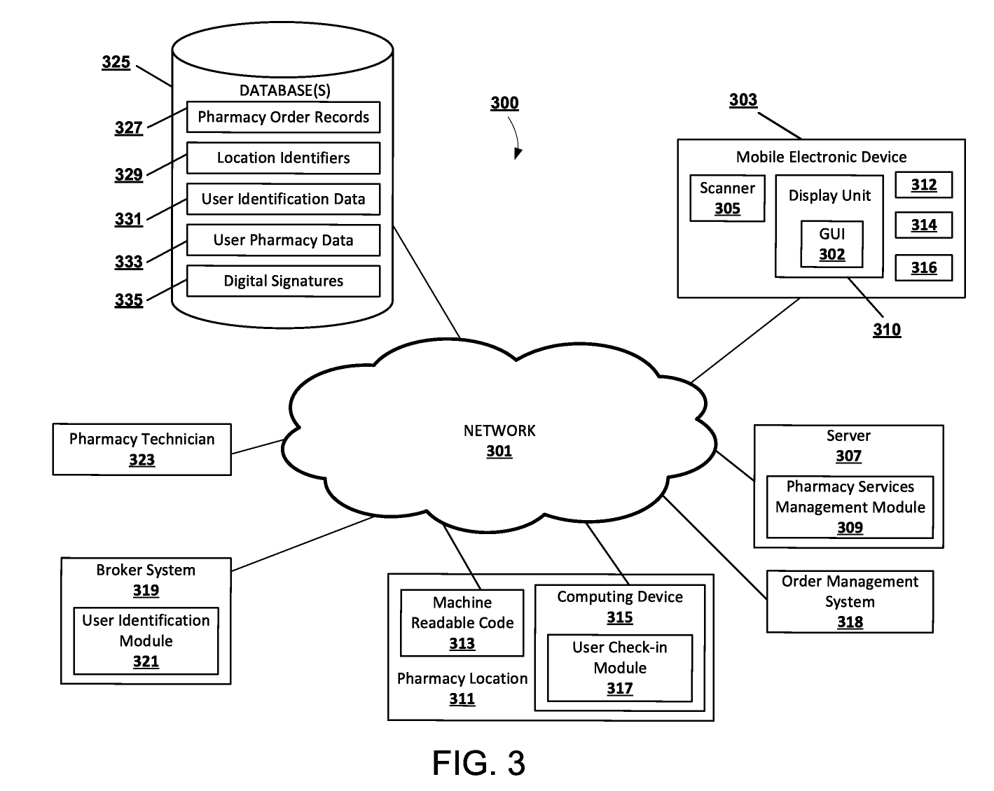

FIG. 3 illustrates a network diagram depicting a system 300 suitable for a distributed implementation of exemplary embodiments. The system 300 can include a network 301, mobile electronic device 303, server 307, order management system 318, computing device 315, machine readable code 313, broker computing system 319, and a database 325. As will be appreciated, various distributed or centralized configurations may be implemented without departing from the scope of the present invention. In exemplary embodiments, server 307 can execute a pharmacy services management module 309, computing device 315 can execute a user check-in module 317, and broker computing system 319 can execute a user identification module 321, each of which can implement one or more of the processes described herein with reference to FIGS. 1-2, or portions thereof. It will be appreciated that the module functionality may be implemented as a greater or lesser number of modules than illustrated and that the same server, computing device, and broker computing system could also host multiple modules. The database 325 can store the pharmacy order records 327, location identifiers 329, user identification data 331, user pharmacy data 333, and digital signatures 335. In some embodiments, the order management system 318 can store various types of orders in addition to pharmacy orders, and the pharmacy services management module 309 can communicate with the order management system 318 to retrieve pharmacy orders, as discussed herein.

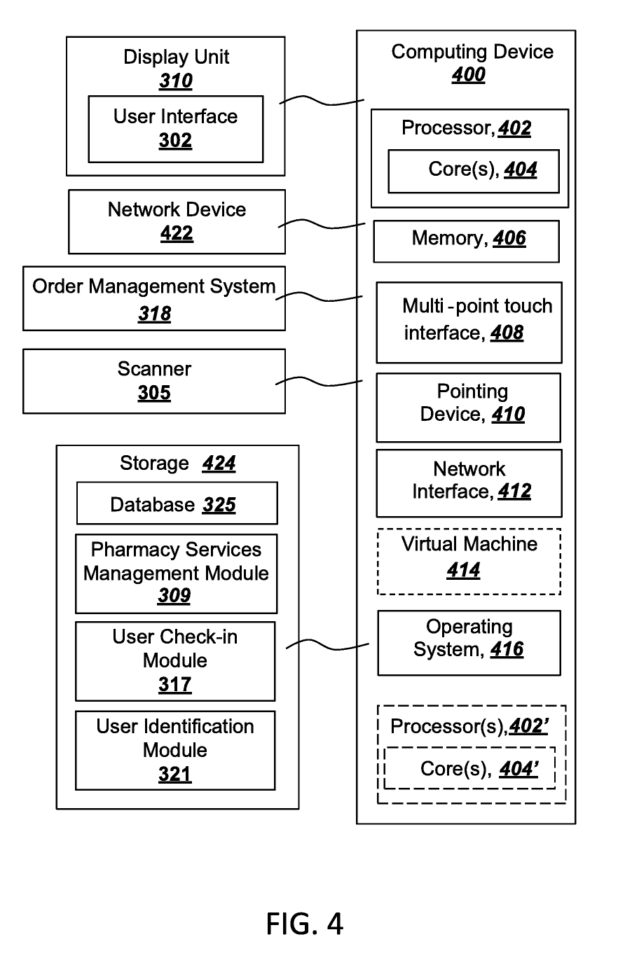

In exemplary embodiments, the mobile electronic device 303 may include a display unit 310, which can display a GUI 302 to a user of the mobile electronic device 303. The mobile electronic device can also include a memory 312, processor 314, and a wireless interface 316, as well as a scanner 305 configured to scan machine-readable codes. In some embodiments, the electronic device 303 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The electronic device 303 may include some or all components described in relation to computing device 400 shown in FIG. 4.

The mobile electronic device 303 may connect to a network 301 via a wired or wireless connection. The mobile electronic device 303 may include one or more applications such as, but not limited to, a mobile pharmacy order application, a web browser, a sales transaction application, an object reader application, and the like.

In exemplary embodiments, the mobile electronic device 303, server 307, order management system 318, computing device 315, machine readable code 313, broker system 319, and database 325 may be in communication with each other via the communication network 301. The communication network 301 may include, but is not limited to, the Internet, an intranet, a LAN (Local Area Network), a WAN (Wide Area Network), a MAN (Metropolitan Area Network), a wireless network, an optical network, and the like. In one embodiment, the mobile electronic device 303, server 307, computing device 315, machine-readable code 313, and broker system 319 can transmit instructions to each other over the communication network 301. In exemplary embodiments, the pharmacy order records 327, location identifiers 329, user identification data 331, user pharmacy data 333, and digital signatures 335 can be stored at the database 325 and received at the electronic device 303, server 307, computing device 315, and broker system 319 in response to a service performed by a database retrieval application.

In some embodiments, the computing device 315 and the machine-readable code 313 are both located in proximity to the pharmacy location 311. Once the user is ready to pick up the pharmacy order, a technician notification can be sent to the pharmacy technician 323, or an electronic device associated with the pharmacy technician 323, in order to let the pharmacy technician that the user is ready to receive the pharmacy order.

FIG. 4 is a block diagram of an exemplary computing device 400 that can be used in the performance of any of the example methods according to the principles described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 310, such as a touch screen display or computer monitor, which can display one or more user interfaces 302 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 310. The computing device 400 can include other suitable conventional I/O peripherals.

The computing device 400 can also be in communication with an order management system 318 that can store pharmacy orders, in addition to various other types of customer orders. The computing device 400 can also include a scanner 305, such as an optical scanner, that can scan and read a machine readable code, as discussed above.

The computing device 400 can also include one or more storage devices 424, such as a hard-drive, CD-ROM, or other non-transitory computer readable media, for storing data and computer-readable instructions and/or software, such as a pharmacy services management module 309, a user check-in module 317, and a user identification module 321 that can implement exemplary embodiments of the methods and systems as taught herein, or portions thereof. Exemplary storage device 424 can also store one or more databases 325 for storing any suitable information required to implement exemplary embodiments. The databases can be updated by a user or automatically at any suitable time to add, delete, or update one or more items in the databases. Exemplary storage device 424 can store one or more databases 325 for storing the pharmacy order records 327, location identifiers 329, user identification data 331, user pharmacy data 333, digital signatures 335, and any other data/information used to implement exemplary embodiments of the systems and methods described herein.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or any other operating system capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for generating pharmacy orders, the system comprising:
(i) a server configured to execute a pharmacy services management module that when executed:
(a) receives a pharmacy order over a network from an application executing on a mobile electronic device associated with a user; and
(b) transmits a first notification to the application executing on the mobile electronic device in response to a pharmacy order being processed, wherein the first notification indicates that the pharmacy order is ready for pickup and indicates a price associated with the pharmacy order;
(ii) a broker computing system configured to execute a user identification module that when executed:
(a) receives from the application executing on the mobile electronic device a location identifier and user identification data, wherein the location identifier is determined in response to the mobile electronic device scanning a machine readable code located at a pharmacy location; and
(b) transmits a second notification to the application executing on the mobile electronic device in response to a payment for the pharmacy order being processed; and
(iii) a computing device located in proximity to the pharmacy location and configured to execute a user check-in module that when executed:
(a) receives the user identification data from the user identification module;
(b) retrieves the pharmacy order associated with the user from the pharmacy services management module following receipt of the user identification data;
(c) transmits a technician notification to a pharmacy technician that the user is available to receive the pharmacy order; and
(d) processes the payment for the pharmacy order associated with the user.

2. The system of claim 1, further comprising:
a user account module that when executed stores the user identification data received from the user and pharmacy data associated with the user.

3. The system of claim 1, wherein the machine readable code includes a one-dimensional barcode, a two-dimensional barcode, or a matrix barcode.

4. The system of claim 1, wherein the second notification includes a receipt for the pharmacy order.

5. The system of claim 1, wherein a digital signature associated with the user is stored in a database and retrieved to process the pharmacy order associated with the user.

6. The system of claim 5, wherein the digital signature is originally received via the application executing on the mobile electronic device.

7. The system of claim 1, wherein the user check-in module is located at an express lane at the pharmacy location, and wherein the user can request processing of the pharmacy order at the express lane via the application executing on the mobile electronic device.

8. A system for generating pharmacy orders, the system comprising:
(i) a server configured to execute a pharmacy services management module that when executed:
(a) receives a pharmacy order associated with a user; and
(b) transmits a first notification to an application executing on a mobile electronic device associated with the user in response to a pharmacy order being processed, wherein the first notification indicates that the pharmacy order is ready for pickup and indicates a price associated with the pharmacy order;
(ii) a broker computing system configured to execute a user identification module that when executed:
(a) receives from the application executing on the mobile electronic device a location identifier that identifies a pharmacy location and user identification data; and
(b) transmits a second notification to the application executing on the mobile electronic device in response to a payment for the pharmacy order being processed; and
(iii) a computing device located in proximity to the pharmacy location and configured to execute a user check-in module that when executed:
(a) receives the user identification data from the user identification module;
(b) retrieves the pharmacy order associated with the user from the pharmacy services management module following receipt of the user identification data;
(c) transmits a technician notification to a pharmacy technician that the user is available to receive the pharmacy order; and
(d) processes the payment for the pharmacy order associated with the user.

9. A method for generating pharmacy orders, the method comprising:
receiving, at a server configured to execute a pharmacy services management module, a pharmacy order over a network from an application executing on a mobile electronic device associated with a user;
transmitting a first notification from the pharmacy services management module to the application executing on the mobile electronic device in response to the pharmacy order being processed, wherein the first notification indicates that the pharmacy order is ready for pickup and indicates a price associated with the pharmacy order;
providing a machine readable code at a pharmacy location that provides a location identifier to the mobile electronic device when scanned by the mobile electronic device;
receiving from the application executing on the mobile electronic device, at a user identification module executed by a broker computing system, the location identifier and user identification data;
receiving the user identification data, from the user identification module, at a user check-in module executed by a computing device located in proximity to the pharmacy location;
retrieving the pharmacy order associated with the user from the pharmacy services management module using the user check-in module following receipt of the user identification data;
transmitting a technician notification to a pharmacy technician that the user is available to receive the pharmacy order;
processing a payment for the pharmacy order associated with the user; and
transmitting a second notification from the user identification module to the application executing on the mobile electronic device in response to the payment for the pharmacy order being processed.

10. The method of claim 9, further comprising:
storing, via a user account module, the user identification data retrieved from the user and pharmacy data associated with the user.

11. The method of claim 9, wherein the machine readable code includes a one-dimensional barcode, a two-dimensional barcode, or a matrix barcode.

12. The method of claim 9, wherein the second notification includes a receipt for the pharmacy order.

13. The method of claim 9, further comprising:
storing a digital signature associated with the user in a database; and
retrieving the digital signature to process the pharmacy order associated with the user.

14. The method of claim 13, further comprising:
receiving the digital signature via the application executing on the mobile electronic device.

15. The method of claim 9, wherein the user check-in module is located at an express lane at the pharmacy location, and wherein the user can request processing of the pharmacy order at the express lane via the application executing on the mobile electronic device.

16. A non-transitory machine readable medium storing instructions executable by a processing device, wherein execution of the instructions causes the processing device to implement a method for generating pharmacy orders, the method comprising:
receiving, at a server configured to execute a pharmacy services management module, a pharmacy order over a network from an application executing on a mobile electronic device associated with a user;
transmitting a first notification from the pharmacy services management module to the application executing on the mobile electronic device in response to the pharmacy order being processed, wherein the first notification indicates that the pharmacy order is ready for pickup and indicates a price associated with the pharmacy order;
providing a machine readable code at a pharmacy location that provides a location identifier to the mobile electronic device when scanned by the mobile electronic device;
receiving from the application executing on the mobile electronic device, at a user identification module executed by a broker computing system, the location identifier and user identification data;
receiving the user identification data, from the user identification module, at a user check-in module executed by a computing device located in proximity to the pharmacy location;
retrieving the pharmacy order associated with the user from the pharmacy services management module using the user check-in module following receipt of the user identification data;
transmitting a technician notification to a pharmacy technician that the user is available to receive the pharmacy order;
processing a payment for the pharmacy order associated with the user; and
transmitting a second notification from the user identification module to the application executing on the mobile electronic device in response to the payment for the pharmacy order being processed.

17. The non-transitory machine readable medium of claim 16, wherein execution of the instructions further causes the processing device to store, via a user account module, the user identification data retrieved from the user and pharmacy data associated with the user.

18. The non-transitory machine readable medium of claim 16, wherein the machine readable code includes a one-dimensional barcode, a two-dimensional barcode, or a matrix barcode.

19. The non-transitory machine readable medium of claim 16, wherein the second notification includes a receipt for the pharmacy order.

20. The non-transitory machine readable medium of claim 16, wherein execution of the instructions further causes the processing device to:
store a digital signature associated with the user in a database; and
retrieve the digital signature to process the pharmacy order associated with the user.
